(19) United States
(12) Patent Application Publication
(10) Pub. No.: US 2025/0244155 A1
(43) Pub. Date: Jul. 31, 2025

(54) METERING DEVICE

(71) Applicant: ALPLA Werke Alwin Lehner GmbH & Co. KG, Hard (AT)

(72) Inventors: Christian SCHARINGER, Hard (AT); Danilo GRIECO, Feldkirch (AT)

(73) Assignee: ALPLA Werke Alwin Lehner GmbH & Co. KG, Hard (AT)

(21) Appl. No.: 18/866,857

(22) PCT Filed: May 17, 2023
(86) PCT No.: PCT/EP2023/063224

§ 371 Date: Nov. 18, 2024

(30) Foreign Application Priority Data
May 19, 2022 (CH) 614/2022

(51) Int. Cl. G01F 11/26

(52) U.S. Cl. CPC G01F 11/263; G01F 11/268

(57) ABSTRACT

A metering device (100) for dispensing a flowable substance out of a container. The metering device comprises a main part (20) for securing to the container, a dispensing device (30) with a discharge opening (31), and a compensating chamber (40) which is connected to the discharge opening (31). The compensating chamber (40) has an invariable volume, and the compensating chamber (40) has a through-opening (41) and a fill opening (42). A piston (50) is arranged within the compensating chamber (40), wherein the piston (50) can be moved linearly within the compensating chamber (40) such that the through-opening (41) can be closed by the piston (50).

The present invention relates to a metering device for dispensing a flowable substance out of a container according to the preamble of the independent claims.

In the daily handling of liquids dispensed from containers, such as detergents, there is a need to dispense them in a predetermined dosage. On the one hand, this is to ensure that certain concentrations of the ingredients are not exceeded, and on the other, to protect the environment. Incorrect dosing can, for example, lead to poor washing results or to part of the dispensed liquid being disposed of unused, or to an increased amount of water, for example, being required to wash out residues of the liquid.

Different solutions for metering liquid are known from the prior art. In a simple embodiment, for example, the lid of a container can be removed, and liquid can be introduced into this lid until the lid is filled up to a measuring line provided therein. The lid, which must then be used again to close the container, is dirty after this process and must be cleaned to prevent the container from becoming dirty.

WO 2021/123 380 A1 discloses a metering device with which a predetermined amount of a liquid can be automatically dispensed. For this purpose, it is intended to provide a container lid in which a control chamber is arranged. Within the control chamber, a closing part is pivotably mounted on a pivot axis. The closing part divides the control chamber into two variable chambers. When the liquid is dispensed, one of the two chambers is filled so that the closing part closes a pouring spout. For this device to function as expected, it is essential that the pivot axis be at a certain angle to the pouring line. However, for pouring, the container must be tilted, in particular turned upside down. It is obvious that, according to the degree to which the container is tilted, the pivot axis assumes a different position, and therefore the kinematic conditions within the metering device change continuously. Rotation of the container around its longitudinal axis also superimposes this inaccuracy. A metering process can therefore hardly be carried out reproducibly. Hardly any user can hold or move a container exactly the same way twice. Furthermore, the metering device from WO 2021/123 380 A1 is suitable only for certain containers which have a relatively large diameter at the container neck. To increase the metering volume, a container must be created whose neck is also larger, i.e., has a larger neck diameter.

The object of the invention is to eliminate at least one or more disadvantages of the prior art. In particular, a metering device is to be provided which makes it possible to repeat a metering process in a reproducible manner and is preferably easy to handle and, in particular, inexpensive to manufacture. Preferably, such a metering device can also be used independently of the position and in particular independently of the neck diameter of a container.

This object is achieved by the devices defined in the independent claims. Further embodiments result from the dependent claims.

A metering device according to the invention for dispensing a flowable substance out of a container comprises a main part for securing to the container, a dispensing device with a discharge opening, and a compensating chamber which is connected to the discharge opening.

The compensating chamber has an invariable volume. In addition, the compensating chamber has a through-opening and a fill opening. A piston is arranged within the compensating chamber. The piston can be moved linearly within the compensating chamber such that the through-opening can be closed by the piston.

The through-opening is an opening into the compensating chamber which connects the compensating chamber to the interior of a container. In the initial position of the piston, i.e., before the container is turned upside down, or at the beginning of the dispensing process in the upside down position, the through-opening connects the inside of the container to the dispensing opening such that liquid can flow out unhindered at this point in time.

The through-opening is preferably arranged at the very end, facing the discharge opening, of the compensating chamber and is preferably directly adjacent to a bottom of the compensating chamber.

The fill opening is also an opening into the compensating chamber which connects the outlet chamber to the interior of the container.

However, the fill opening is characterized by the fact that it is separated from the discharge opening by the piston located in the compensating chamber. In contrast, the through-opening is in fluid communication with the discharge opening, at least at the beginning of a liquid dispensing process.

This fluid communication can be interrupted by the piston. The linear mobility of the piston allows the metering device to be used substantially unaffected by the tilt angle of the container, but also independently of a rotation of the container about its longitudinal axis.

In other words, the piston in its lower end position, i.e., when used upside down, closes the through-opening. This closure interrupts the dispensing process.

The through-opening is preferably arranged on the side of the compensating chamber. This arrangement makes it possible for the piston to pass over this through-opening during its movement, causing the through-opening to become continuously smaller until, in the end position of the piston, it is completely closed.

The longitudinal axis of a container is typically defined by a connection from a container bottom to a container opening. Using the example of a rotationally symmetrical container, such as a bottle for cooking oil, the longitudinal axis is identical to the axis of rotation of the container.

By closing the through-opening with the piston, further introduction of liquid into the compensating chamber can be prevented. In addition, this arrangement allows a metering process to be terminated with an indication that the metering process is nearing completion. The piston does not close the through-opening suddenly and immediately, but, rather, the through-opening becomes continuously smaller as it overlaps with the piston, so that the flow of the dispensed liquid also decreases. This decrease lets the user know that the metering process is about to be completed.

The invariable volume of the compensating chamber ensures the reproducibility of the metering process.

Preferably, the compensating chamber is circular-cylindrical; accordingly, a piston located therein can also be circular-cylindrical. The piston can therefore float freely within the compensating chamber and is not restricted in either its rotational movement or its linear movement.

The design with a linearly movable piston also makes it possible, for example, to design it with a relatively small diameter and to increase or decrease an axial expansion of the compensating chamber accordingly in order to provide a correspondingly larger or smaller time delay, and thus a correspondingly larger or smaller dispensing volume. This makes it possible to use the metering device even for containers which have relatively small discharge openings or container necks.

An axial length of the piston preferably corresponds to at least 0.8 times the diameter of the piston. This reliably prevents the piston from tipping or jamming within the compensating chamber.

As already explained, the compensating chamber is connected to the discharge opening. The discharge opening is in particular an integral part of the compensating chamber and closes the compensating chamber in the discharge direction of the liquid.

However, the discharge opening can also be formed in a separate element, wherein said element closes the compensating chamber. It can be provided that this element be designed as a cover for closing the compensating chamber. Alternatively, however, this element can also be part of an adjustment device by means of which the metering amount can be adjusted.

Opposite this discharge opening, the compensating chamber has a bottom. A casing extends from the bottom of the compensating chamber towards the discharge opening.

The through-opening is preferably arranged in the casing of the compensating chamber. By being arranged in the casing, the through-opening can be easily closed with the piston. The piston functions like an aperture which covers the through-opening. In other words, the through-opening is arranged laterally on the compensating chamber. It forms a window in the casing.

The clear cross-section of the through-opening can be substantially rectangular. However, it can also be provided that the cross-section taper or widen in the direction of the discharge opening, i.e., in the direction of the longitudinal axis and thus also in the direction of the linear movement of the piston, in order, for example, to achieve a certain decrease in the liquid flow during the metering process.

Preferably, the fill opening is arranged in the bottom of the compensating chamber. The arrangement in the bottom ensures that the compensating chamber can be evenly supplied with liquid regardless of its position. The fill opening can preferably be arranged centrally in the bottom.

Preferably, the piston divides the compensating chamber into a through-flow chamber and a filling chamber. The filling chamber is or can be brought into fluid communication with the interior of the container exclusively via the fill opening. In particular, no further connections are provided, such as one-way valves or the like.

This allows the simple and reproducible production of the metering device. At the same time, a single fill opening facilitates the reproducibility of the metering process.

The piston is preferably designed in the shape of a cup, wherein said cup is open at the top when the container is in the upside-down position. For this purpose, the piston has a wall or apron which extends towards the interior of the container and thus towards the fill opening. On the one hand, this design provides a simple way of guiding the piston in the compensating chamber, and, on the other, it also ensures that the piston is always supplied with a minimal amount of liquid in the filling chamber. Due to this specific design, the filling chamber already has a minimal volume. The bottom of the piston, i.e., the region facing the dispensing opening, is preferably flat and has no significant elevations. This makes it possible to create a seal to the bottom of the through-flow chamber.

Preferably, a cross-section of the fluid communication between the interior of the container and the filling chamber is invariable. In other words, there is a constant connection between the filling chamber and the interior of the container, regardless of the state of the metering device. In other words, the connection is constant and consistent before, during, and after the dispensing process. This creates reproducible conditions for recurring processes.

A ventilation opening can be provided within the metering device to ventilate the interior of the container.

The metering device as described here is particularly suitable for dispensing liquids from containers which are difficult or impossible to compress or deform. In order for a liquid to be dispensed from such containers, the volume of liquid within the container must be replaced. Typically, this happens by allowing ambient air to flow into the interior of the container. This is made possible by a corresponding ventilation opening.

The piston is preferably arranged in a free-floating manner in the compensating chamber. This ensures that the piston is not hindered in its movement in any way.

The metering device can comprise an adjustment device for adjusting a clear cross-section of the through-opening. The metering amount can be determined by adjusting the cross-section. According to the size of the cross-section, more or less liquid flows into the through-flow chamber. However, because the filling chamber is essentially always filled at a constant speed, and the through-opening is also closed at a constant speed by the piston, the volume of liquid dispensed changes as a function of the post-flow speed and/or post-flow amount.

It can be provided that the adjustment device be arranged so as to be rotatable. By arranging the adjustment device so as to be rotatable, the through-opening can, for example, be closed in the circumferential direction of the compensating chamber.

The discharge opening can be arranged on the adjustment device. This arrangement allows the adjustment device to perform a plurality of functions simultaneously. In particular, a separate cover no longer needs to be provided for the compensating chamber; rather, the adjustment device can close the compensating chamber and at the same time provide the discharge opening.

Additionally or alternatively, the ventilation opening for ventilating the interior of the container can also be arranged on the adjustment device.

A pourer can be arranged at the discharge opening to direct the liquid discharge in a certain direction and/or to prevent spilling. If the discharge opening is arranged on the adjustment device and is typically designed with a pourer, the ventilation opening for ventilating the interior of the container can be arranged opposite the pourer. This ensures that, during normal use, i.e., when liquid is being dispensed, the ventilation opening for ventilating the interior of the container is directed upwards.

A further aspect relates to a container comprising a metering device as described herein. This makes it possible to provide a coordinated system. In particular for containers which are rigid and not compressible, such a combination is easy to design so that the metering amount is reproducible.

The invention is explained below with reference to schematic figures. In the figures:

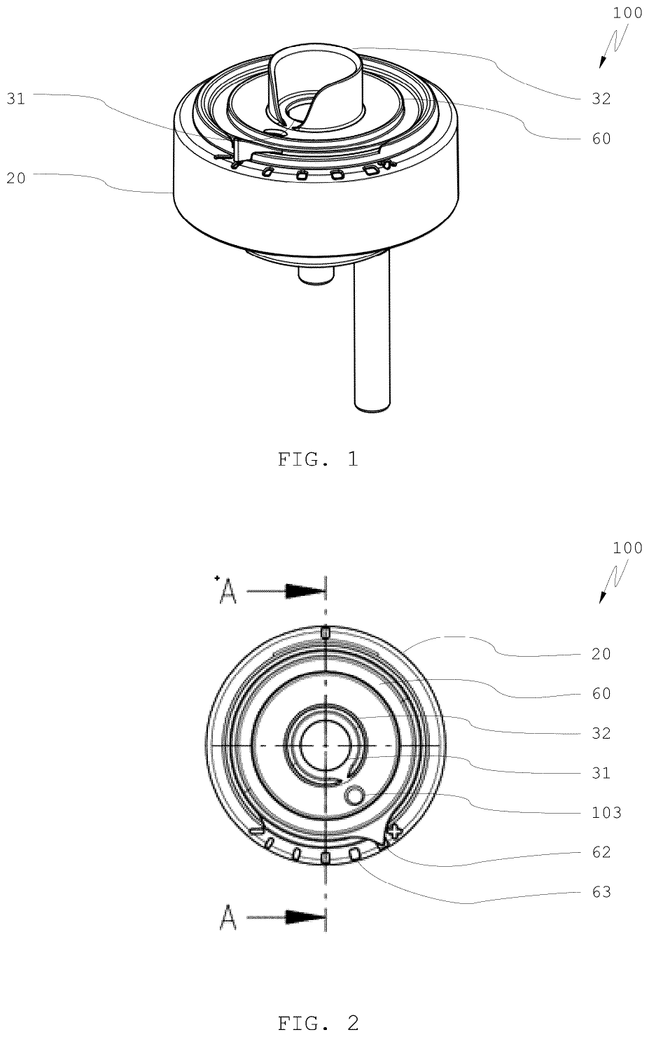

FIG. 1 is a perspectival view of a metering device;

FIG. 2 is a plan view of the metering device according to FIG. 1;

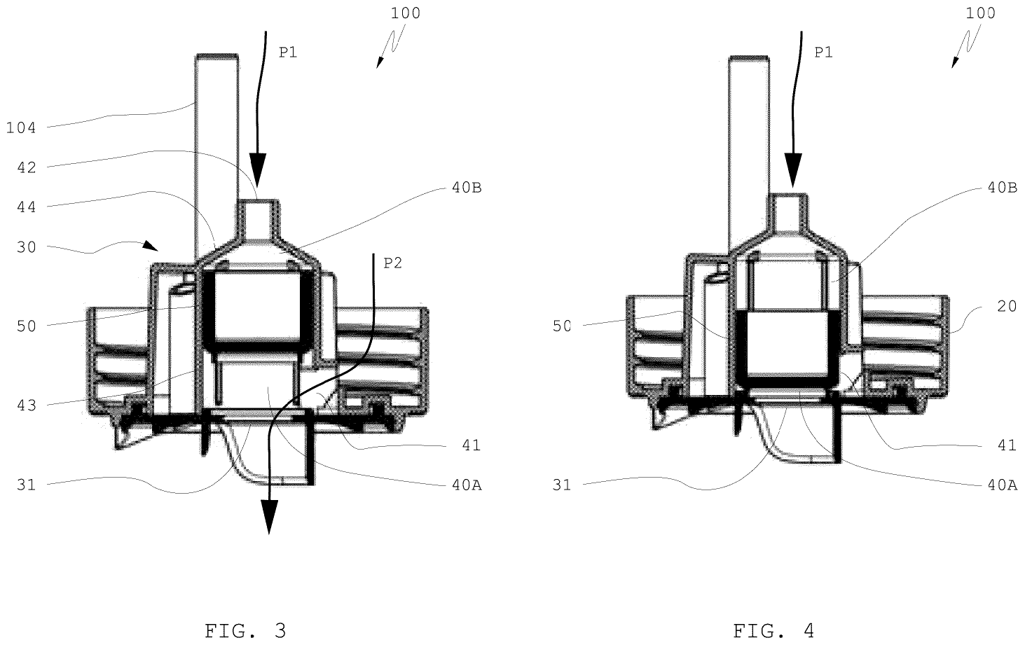

FIG. 3 is a sectional view along the section line A-A of FIG. 2;

FIG. 4 is the sectional view according to FIG. 3 after completion of fluid dispensing;

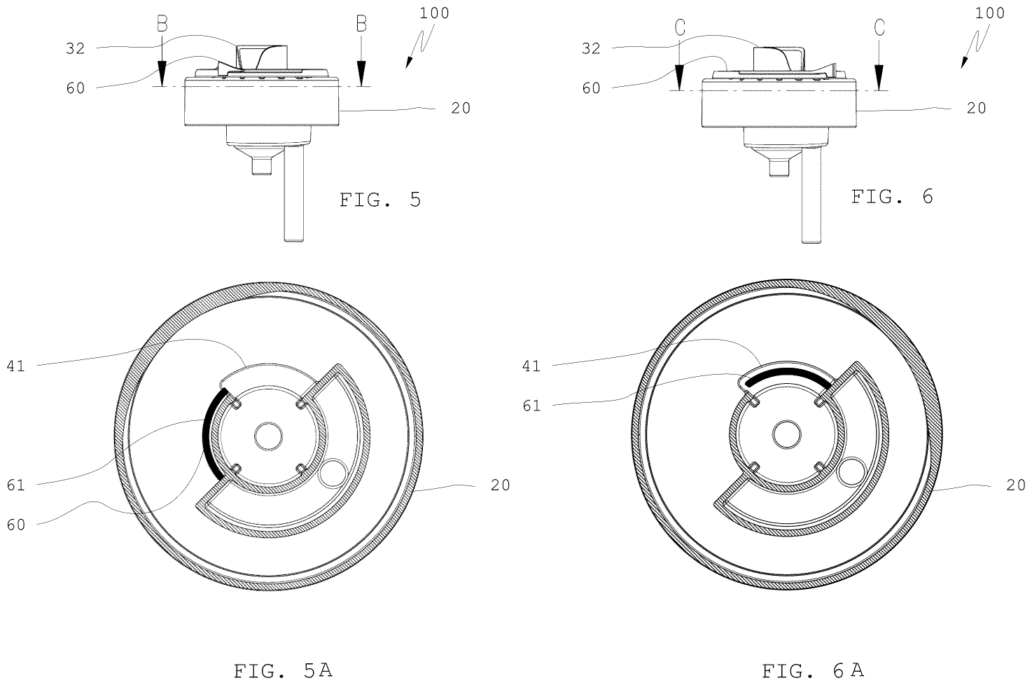

FIGS. 5 and 5A are a side view and associated sectional view of the metering device according to FIG. 1;

FIGS. 6 and 6A are a further side view and associated sectional view of the metering device according to FIG. 1.

FIG. 1 is a perspectival view of a metering device 100. The metering device 100 has a main part 20. The main part 20 is provided with a thread (not visible here) in order to secure the metering device 100 to a container (not shown here).

The metering device 100 has an adjustment device 60 for setting the amount of the dose to be dispensed. A discharge opening 31 is located centrally on the adjustment device 60. A pourer 32 is arranged downstream of said discharge opening. The pourer 32 allows the liquid to be poured out without spilling.

FIG. 2 is a plan view of the metering device 100 according to FIG. 1. The adjustment device 60 can be seen in FIG. 2. Said adjustment device has an indicator 62.

A scale 63 is arranged on the main part 20, which, together with the indicator 62, indicates which metering amount has been selected. The adjustment device 60 is rotatably mounted in the main part 20. The amount of liquid to be dispensed can be adjusted by turning the adjustment device 60. This is indicated by the position of the indicator 62 in relation to the scale 63.

FIG. 3 is a sectional view along the section line A-A of FIG. 2. In this sectional view, it can be seen that a thread for securing to a container is arranged within the main part 20. The representation according to FIG. 3 is an overhead representation, i.e., a representation in which the metering unit 100 is shown at the beginning of a metering process.

It can be seen that a compensating chamber 40 is arranged centrally in the main part 20. A piston 50 is located within the compensating chamber 40, which piston divides the compensating chamber 40 into a through-flow chamber 40A and a filling chamber 40B. The piston 50 is arranged in a free-floating manner within the compensating chamber 40. This allows the metering device 100 to be used regardless of position.

The filling chamber 40B is connected to the interior of a container via the fill opening 42. The through-flow chamber 40A is also connected to the interior of the container via a through-opening 41. The filling chamber 40B is separated from the discharge opening by the presence of the piston 50.

The compensating chamber 40 has a bottom 44 and a casing 43. The fill opening 42 is formed centrally in the bottom 44. The bottom 44 is slightly conically tapered in the direction of the fill opening 42. This ensures that the piston 50 can move freely within the compensating chamber 40. Liquid in the filling chamber 40B can flow out unhindered.

The beginning of the metering process can be seen in FIG. 3. At the beginning of the metering process, the piston 50 is in the starting position shown here, wherein said starting position is achieved by storing the container in an upright state. As a result, the piston 50 sinks downwards and is in the position shown here. To dispense liquid from the container, said container is turned upside down together with the metering device 100, and the metering device 100 is thus in the position shown in FIG. 3.

In this position, liquid can flow from the interior of the container into the through-flow chamber 40A through the through-opening 41 and correspondingly flow out of this through-flow chamber 40A through the discharge opening 31. This is illustrated by the arrow P2. At the same time, liquid flows from the interior of the container into the filling chamber 40B through the fill opening 42 and fills said filling chamber with liquid. The liquid moves the piston 50 in the direction of the discharge opening 31. During this movement, the piston 50 begins to pass over the through-opening 41. According to the progress of movement of the piston 50, the through-opening 41 becomes smaller, until it is completely closed. As soon as the through-opening 41 is completely closed, the liquid flow along the arrow P2 is interrupted, and no further liquid is dispensed through the discharge opening 31. As can be seen from FIG. 4, this state, i.e., the complete closure of the through-opening, occurs when the piston is in its lower end position. The amount of liquid dispensed can be adjusted by the adjustment device 60 (see FIG. 1). By turning the adjustment device, the initial cross-section of the through-opening 41 becomes comparatively larger or smaller. This process is explained in detail below with reference to FIGS. 5, 5A, 6 and 6A.

FIG. 4 shows the completion of the metering process or dispensing process, as already described. As can be seen from FIG. 4, the piston 50 has completely closed the through-opening 41 so that no further liquid can flow into the through-flow chamber 40A, the volume of which has been completely reduced by the movement of the piston 50. At the same time, filling chamber 40B is completely filled with liquid. In order to make the metering device 100 available again for the next metering process, it must be returned to its original upright position, i.e., rotated by 180 degrees with respect to the position shown here in FIG. 4. In this position rotated by 180 degrees, the liquid which has accumulated in the filling chamber 40B flows back into the container.

To prevent undesirable conditions from forming in the container, such as a state of negative pressure, an opening 103 is provided on the metering device 100 (see FIG. 1) to ventilate the interior of the container. The opening 103 opens into the ventilation tube 104.

FIG. 5 is a side view of the metering device 100 according to FIG. 1, and FIG. 5A is a corresponding sectional view along the section line B-B of FIG. 5.

The main part 20 with the adjustment device 60 arranged thereon, which opens into the pourer 32, is visible. The adjustment device 60 is mounted on the main part 20 so as to be rotatable relative to the main part 20.

The adjustment device 60 has an aperture 61 which can be brought into overlap with the through-opening 41. In FIG. 5A, in the sectional view, the position of the aperture 61 is shown in which the through-opening 41 is completely open. This corresponds to a high metering amount.

FIGS. 6 and 6A show a representation comparable to FIGS. 5 and 5A. In this representation, the adjustment device 60 is rotated so that the aperture 61 almost completely covers the through-opening 41 and leaves only a small through-flow cross-section open. This corresponds to a small metering amount.

1. A metering device (100) for dispensing a flowable substance from a container, comprising a main part (20) for securing to the container, a dispensing device (30) with a discharge opening (31), and a compensating chamber (40) which is connected to the discharge opening (31), wherein the compensating chamber (40) has an invariable volume and wherein the compensating chamber (40) has a through-opening (41) and a fill opening (42), wherein a piston (50) is arranged within the compensating chamber (40), wherein the piston (50) can be moved linearly within the compensating chamber (40) such that the through-opening (41) can be closed by the piston (50).

2. The metering device (100) according to claim 1, wherein the compensating chamber (40) is circular-cylindrical.

3. The metering device (100) according to claim 1, wherein the through-opening (41) is arranged in a casing (43) of the compensating chamber (40).

4. The metering device (100) according to claim 1, wherein the fill opening (42) is arranged in a bottom (44) of the compensating chamber (40).

5. The metering device (100) according to claim 1, wherein the piston (50) divides the compensating chamber into a through-flow chamber (40A) and a filling chamber (40B), wherein the filling chamber (40B) is or can be brought into fluid communication with an interior of the container exclusively via the fill opening (42).

6. The metering device (100) according to claim 5, wherein a cross-section of the fluid communication between the interior of the container (100) and the filling chamber (40B) is invariable.

7. The metering device (100) according to claim 1, wherein a ventilation opening (102) for ventilating an interior of the container (100) is arranged in the metering device (100).

8. The metering device (100) according to claim 1, wherein the piston (50) is arranged in a free-floating manner in the compensating chamber (40).

9. The metering device (100) according to claim 1, wherein the metering device (100) has an adjustment device (60) for adjusting a clear cross-section of the through-opening (41).

10. The metering device (100) according to claim 9, wherein the adjustment device (60) is arranged so as to be rotatable.

11. The metering device (100) according to claim 9, wherein the discharge opening (31) is arranged on the adjustment device (60).

12. The metering device (100) according to claim 7, wherein the ventilation opening (102) is arranged on the adjustment device (60).

13. A container, comprising a metering device (100) according to claim 1.

14. The metering device (100) according to claim 10, wherein the discharge opening (31) is arranged on the adjustment device (60).

15. The metering device (100) according to claim 9, wherein the ventilation opening (102) is arranged on the adjustment device (60).
